(19) United States
(12) Patent Application Publication
(10) Pub. No.: US 2013/0083700 A1
(43) Pub. Date: Apr. 4, 2013

(54) METHODS AND APPARATUS FOR CENTRALIZED MANAGEMENT OF ACCESS AND AGGREGATION NETWORK INFRASTRUCTURE

(71) Applicants: Pradeep SINDHU, Los Altos Hills, CA (US); Abhijit CHOUDHURY, Cupertino, CA (US); James MURPHY, Alameda, CA (US); Raghavendra MALLYA, Cupertino, CA (US); Pranay POGDE, Sunnyvale, CA (US); Phalguni NANDA, San Jose, CA (US); Jayabharat BODDU, Los Altos, CA (US)

(72) Inventors: Pradeep SINDHU, Los Altos Hills, CA (US); Abhijit CHOUDHURY, Cupertino, CA (US); James MURPHY, Alameda, CA (US); Raghavendra MALLYA, Cupertino, CA (US); Pranay POGDE, Sunnyvale, CA (US); Phalguni NANDA, San Jose, CA (US); Jayabharat BODDU, Los Altos, CA (US)

(73) Assignee: JUNIPER NETWORKS, INC.

(21) Appl. No.: 13/252,860

(22) Filed: Oct. 4, 2011

(51) Int. Cl. H04W 40/00; H04L 12/28

(52) U.S. Cl. 370/255

(57) ABSTRACT

In some embodiments, an apparatus comprises a core network node configured to be operatively coupled to a set of network nodes. The core network node is configured to define configuration information for a network node from the set of network nodes based on a template, where the configuration information excludes virtual local area network (VLAN) information or IP subnet information. The core network node is further configured to send the configuration information to the network node.

### CROSS-REFERENCE TO RELATED APPLICATIONS

This application is related to co-pending U.S. patent application Ser. No. ______ (Attorney Docket JUNI-095 108200-2150), filed on the same date herewith, and entitled “Methods and Apparatus for a Converged Wired/Wireless Enterprise Network Architecture;” U.S. patent application Ser. No. ______ (Attorney Docket JUNI-097 108200-2153), filed on the same date herewith, and entitled “Methods and Apparatus for Enforcing a Common User Policy within a Network;” U.S. patent application Ser. No. ______ (Attorney Docket JUNI-098 108200-2154), filed on the same date herewith, and entitled “Methods and Apparatus for a Scalable Network with Efficient Link Utilization,” U.S. patent application Ser. No. ______ (Attorney Docket JUNI-096 108200-2152), filed on the same date herewith, and entitled “Methods and Apparatus for a Self-organized Layer-2 Enterprise Network Architecture,” each of which is incorporated herein by reference in its entirety.

### BACKGROUND

Some embodiments described herein relate generally to enterprise networks, and, in particular, to methods and apparatus for centrally managing network elements at for example, the access and aggregation layers in an enterprise network architecture.

In some known enterprise networks, management of network elements at the aggregation and access layers is done in a distributed fashion, where each individual network element is configured and managed separately. This distributed management approach, however, is troublesome and tedious for a network administrator because in a large deployment of enterprise network more than thousands of network elements can exist at the access and aggregation layers.

Accordingly, a need exists for a management infrastructure of an enterprise network that can centrally manage network elements at the access and aggregation layers for both wired and wireless portions of the enterprise network.

### SUMMARY

In some embodiments, an apparatus comprises a core network node configured to be operatively coupled to a set of network nodes. The core network node is configured to define configuration information for a network node from the set of network nodes based on a template, where the configuration information excludes virtual local area network (VLAN) information or IP subnet information. The core network node is further configured to send the configuration information to the network node.

### BRIEF DESCRIPTION OF THE DRAWINGS

FIG. 1 is a schematic illustration of an overlay enterprise network having access points, access network nodes, aggregation network nodes, core network nodes, and a WLAN controller, where the access network nodes and aggregation network nodes are managed in a distributed fashion.

FIG. 2 is a schematic illustration of a homogeneous enterprise network having access points, access network nodes, aggregation network nodes, core network nodes, and a network administrator, where the access points, access network nodes, and aggregation network nodes are managed in a centralized fashion, according to an embodiment.

FIG. 3 is a system block diagram of an access point, according to an embodiment.

FIG. 4 is a system block diagram of an access network node, according to an embodiment.

FIG. 5 is a system block diagram of a core network node, according to an embodiment.

FIG. 6 is a schematic illustration of a heterogeneous enterprise network having access points, access network nodes, aggregation network nodes, core network nodes, a WLAN controller, and a network administrator, according to an embodiment.

FIG. 7 is a flow chart of a method for configuring a network node, according to an embodiment.

FIG. 8 is a flow chart of a method for monitoring network nodes in an enterprise network and troubleshooting a network node, according to an embodiment.

### DETAILED DESCRIPTION

In some embodiments, an enterprise network includes a core network node operatively coupled to a set of network nodes, which include a set of wired network nodes and a set of wireless network nodes. The core network node is configured to receive an initiation signal from a first network node from the set of network nodes. Alternatively, the core network node receives a configuration update signal from a network administrator. The core network node is then configured to define configuration information for the first network node based on a template in response to receiving the initiation signal or receiving the configuration update signal, where the configuration information excludes virtual local area network (VLAN) information or IP subnet information. The core network node is then configured to send the configuration information defined for the first network node to the first network node. In some embodiments, the configuration information for the first network node is sent to the first network node via an in-band channel.

Similarly, the core network node is configured to define configuration information for a second network node from the set of network nodes, based on the same template that is used to define configuration information for the first network node. The core network node is further configured to send the configuration information defined for the second network node to the second network node, based on a multicast signal that is also used to send the configuration information defined for the first network node to the first network node. In some embodiments, the core network node is configured to define configuration information for each network node from the set of network nodes based on a set of templates, and then send the configuration information to each network node from the set of network nodes through an in-band channel. In some embodiments, the set of templates are retrieved from a template table stored in a memory operatively coupled to the core network node.

In some embodiments, the set of wired network nodes includes one or more aggregation network nodes and one or more access network nodes, and the set of wireless network nodes includes one or more access points. The core network node is configured to receive a first tunneled packet associated with a first session from a wired network node from the set of wired network nodes. The core network node is also configured to receive a second tunneled packet associated with a second session from a wireless network node from the set of the wireless network nodes through intervening wired network nodes from the set of wired network nodes. Furthermore, the core network node is configured to send through a control plane tunnel VLAN information and/or IP subnet information to a wired user communication device associated with the first tunneled packet, and send through a control plane tunnel VLAN information and/or IP subnet information to a wireless user communication device associated with the second tunneled packet.

Additionally, the core network node is configured to receive monitor information from each network node from the set of network nodes, and send a troubleshoot signal to the first network node based on the monitor information received from at least one network node from the set of network nodes, such that the first network node does not receive any other troubleshoot signal originated from a remaining portion of the enterprise network, including any other network node from the set of network nodes. In other words, in some embodiments, the first network node is troubleshot by the core network node only. In some embodiments, the monitor information from each network node is sent to the core network node and the troubleshoot signal from the core network node is sent to the first network node all through the control plane of the enterprise network. Furthermore, in some embodiments, the core network node is configured to produce integrated monitor information based on the monitor information received from each network node, and then output a representation of the integrated monitor information to the network administrator.

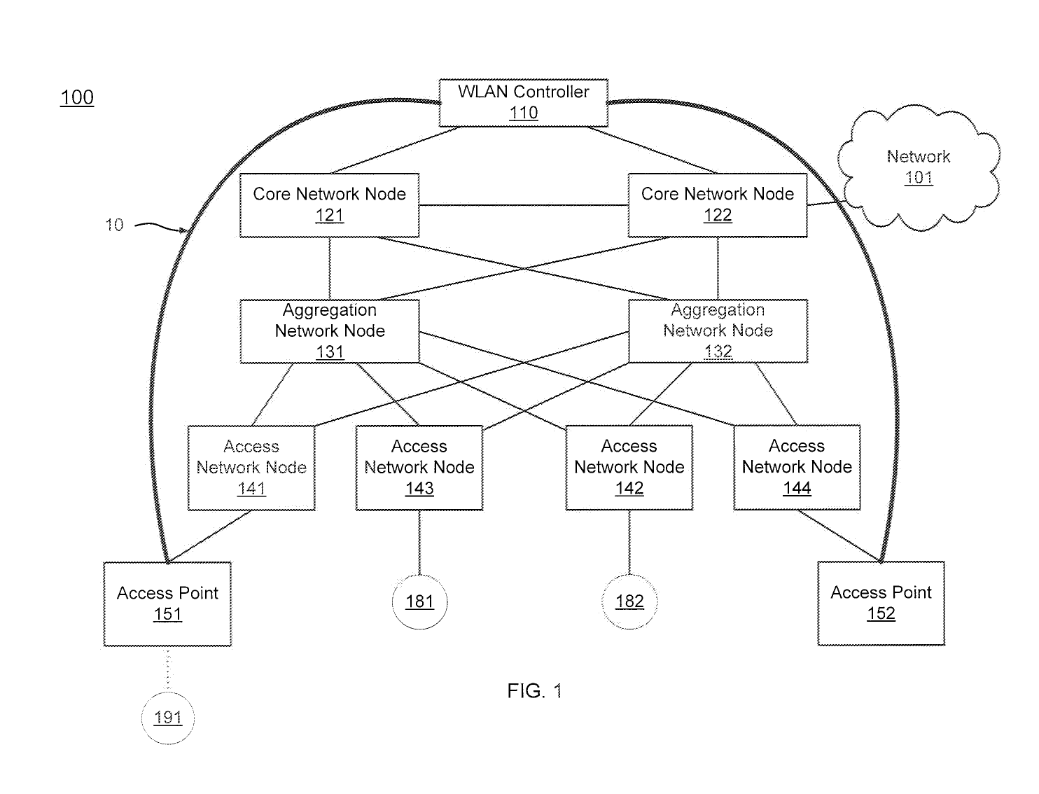

FIG. 1 is a schematic illustration of an overlay enterprise network 100 having access points (e.g., access point 151, access point 152), access network nodes (e.g., access network node 141-144), aggregation network nodes (e.g., aggregation network node 131, aggregation network node 132), core network nodes (e.g., core network node 121, core network node 122), and a WLAN (wireless local area network) controller 110, where the access network nodes and aggregation network nodes are managed in a distributed fashion. Specifically, each wired network node, including access network node 141-144 and aggregation network node 131-132, is individually configured and managed in accordance with its physical connectivity to other network nodes in the overlay enterprise network 100. On the other hand, WLAN controller 110 is configured to configure and manage each wireless network node of the overlay enterprise network 100, including access point 151-152.

A core network node (e.g., core network node 121, core network node 122) can be a high-capacity switching device positioned in the physical core, or backbone, of an enterprise network (e.g., the overlay enterprise network 100). In some cases, a core network node is also known as a core switch, a tandem switch or a backbone switch. In the overlay enterprise network 100, core network node 121 and core network node 122 are configured to connect the access devices (e.g., access network node 141-144, access point 151-152) and WLAN controller 110 with network 101, such that access to information services (e.g., persistent data and applications) located at network 101 can be provided to users that are coupled to the overlay enterprise network 100 via wired or wireless user communication devices (e.g., wired user communication device 181, wired user communication device 182, wireless user communication device 191). Specifically, core network node 121 and core network node 122 operatively connect aggregation network node 131 and aggregation network node 132 with network 101, and forward packets of wired and/or wireless sessions between aggregation network node 131, aggregation network node 132 and network 101 based on IP routing services. In other words, core network node 121 and core network node 122 act as a router working in layer 3 (i.e., network layer) of the OSI (open systems interconnection) model for the overlay enterprise network 100. In the overlay enterprise network 100, core network nodes are configured to manage wired sessions only, while wireless sessions are managed by WLAN controller 110, as described in detail below.

Shown in FIG. 1, network 101 can be any network that is directly connected to the overlay enterprise network 100 through one or more core network nodes. For example, network 101 can be a data center network including one or more data servers that provide information services. For another example, network 101 can be a WAN (wide area network) access network that is used to connect the overlay enterprise network 100 to remote data resources. For yet another example, network 101 can be the Internet. Typically, the overlay enterprise network 100 acts as an access network providing, for wired or wireless clients, access to data resources, applications, and information services that are located at or provided from network 101.

In the overlay enterprise network 100, the access network nodes (e.g., access network node 141-144) can be any device that can directly connect one or more wired user communication devices (e.g., wired user communication device 181, wired user communication device 182) to the overlay enterprise network 100, such as a hub, an Ethernet switch, etc. In some cases, an access network node is also known as an access switch, a network switch, or a switching hub. Furthermore, as described in detail herein, access network node 141-144 is configured to ensure packets are delivered between one or more aggregation network nodes, one or more wired user communication devices, and/or one or more access points that are coupled to the access network nodes. In the overlay enterprise network 100, a wired user communication device can be any device that can receive packets from and/or send packets to an access network node through a wired connection, such as a desktop computer, a workstation, a printer, etc.

In the overlay enterprise network 100, the aggregation network nodes (e.g., aggregation network node 131-132) can be any switching device that is used to aggregate multiple access network nodes and ensure packets are properly routed within the network, such as a router, a layer-3 switch, etc. Furthermore, as described in detail herein, aggregation network node 131-132 is configured to route or switch packets received from one or more access network nodes to another access network node or a core network node, based on the routing information provided in the packet and the routing policy implemented at aggregation network node 131-132. In some embodiments, a collection of aggregation network nodes and associated access devices (e.g., access network nodes, access points) having a common connection to a redundant set of core network nodes are referred to as a pod. As shown in FIG. 1, aggregation network node 131-132 with their associated access network node 141-144 and access point 151-152 comprise a pod.

In the overlay enterprise network 100, core network node 121-122, aggregation network node 131-132, and access network node 141-144 are configured collectively to manage and forward wired traffic for one or more wired user communication devices that are operatively coupled to one or more access network nodes. Wired network nodes including access network nodes 141-144 and aggregation network nodes 131-132 are configured to switch or route packets of a wired session that are received from a wired user communication device, to another wired network node or a core network node, based on a destination address (e.g., a destination IP address, a destination MAC address) included in the packets. More specifically, some wired traffic that is received at an aggregation network node from an access network node may be switched to another access network node from the aggregation network node if the traffic is destined to a destination device within the same pod. In contrast, the wired traffic destined to a destination device located in another pod is forwarded to a core network node, from which the traffic is forwarded into the other pod. For example, if wired user communication device 181 sends a packet to access network node 143 destined to wired user communication device 182, the packet can be first forwarded by access network node 143 to aggregation network node 131. Then, based on the destination IP address or MAC address included the packet, the packet is further forwarded by aggregation network node 131 to access network node 142, which finally sends the packet to wired user communication device 182. For another example, if wired user communication device 181 sends a packet to access network node 143 destined to a device located in network 101, the packet can be first forwarded by access network node 143 to aggregation network node 131. Then, based on the destination IP address or MAC address included the packet, the packet is further forwarded by aggregation network node 131 to core network node 122, which sends the packet into network 101 for further routing.

In the overlay enterprise network 100, wired network nodes including access network nodes 141-144 and aggregation network nodes 131-132 are configured and managed in a distributed fashion. Specifically, each wired network node is individually configured and managed in accordance with its physical connectivity to other network nodes in the overlay enterprise network 100. The node management includes for example, configuration management (including for example image management), accounting management, performance management, security management, fault management (including for example monitoring, and/or troubleshooting), etc. For example, after access network node 143 is coupled to the overlay enterprise network 100 (e.g., connected to aggregation network node 131 and aggregation 132), access network node 143 is manually configured by a network administrator (not shown in FIG. 1) based on the location of access network node 143 in the overlay enterprise network 100, such that a communication channel is established between access network node 143 and each of aggregation network nodes 131-132. For another example, aggregation network node 132 and access network node 144 are independently monitored by the network administrator such that when, for example, data packets from aggregation network node 132 cannot be successfully delivered to access network node 144, the problem is detected and then aggregation network node 132 and access network node 144 may both be troubleshot by the network administrator.

In the overlay enterprise network 100, wireless equipments, including WLAN controller 110 and access points 151-152, forward wireless traffic that is received from one or more wireless user communication devices (e.g., wireless user communication device 191). Specifically, WLAN controller 110 can be any device that can automatically handle the configuration of multiple access points, and act as a centralized controller configured to manage wireless sessions in an overlay of the wired network portion of the overlay enterprise network 100. An access point can be any device that connects a wireless user communication device to a wired network portion of an enterprise network (e.g., via an access network node as shown in FIG. 1) using, for example, Wi-Fi, Bluetooth or other wireless communication standards. In some cases, an access point can be located on the same device together with an access network node, such as a wireless Ethernet router equipped with a wireless transceiver. In some other cases, an access point can be a stand-alone device, such as a wireless access point (WAP). Similar to a wired user communication device, a wireless user communication device can be any device that can receive packets from and/or send packets to an access point through a wireless connection, such as, for example, a mobile phone, a Wi-Fi enabled laptop, a Bluetooth earphone, etc.

In the overlay enterprise network 100, WLAN controller 110 and access points 151-152 are configured collectively to manage and forward wireless traffic through intervening wired network nodes and core network nodes. Specifically, WLAN controller 110 is configured to receive encapsulated packets of a wireless session from access point 151 or access point 152 via a layer-3 tunnel through intervening wired network nodes and core network nodes, decapsulate the packets, and then bridge the decapsulated packets to core network node 121 or core network node 122, from which the decapsulated packets are further forwarded to the destination. Similarly, WLAN controller 110 is configured to receive packets of the wireless session from core network node 121 or core network node 122 destined to access point 151 or access point 152, encapsulate the packets according to a layer-3 tunneling protocol, and then send the encapsulated packets to access point 151 or access point 152 via a layer-3 tunnel through intervening wired network nodes and core network nodes, where the encapsulated packets are decapsulated and forwarded to a wireless user communication device. In some cases, a layer-3 tunnel can be an Ethernet over layer-3 tunnel, such as a CAPWAP (control and provisioning of wireless access points) tunnel, a GRE (generic routing encapsulation) tunnel, etc.

In contrast to wired network nodes, wireless network nodes of the overlay enterprise network 100 including access points 151-152 can be configured and managed by WLAN controller 110 in a centralized fashion. Specifically, the functionalities of configuration, monitoring and troubleshooting for access points 151-152 in the overlay enterprise network 100 can be centralized in WLAN controller 110. Thus, access points 151-152 are directly monitored by WLAN controller 110 by sending their monitoring information to WLAN controller 110 via a tunnel (e.g., the tunnel represented by 10 in FIG. 1) through intervening wired network nodes. Meanwhile, WLAN controller 110 is configured to send configuration information and troubleshoot instructions to access points 151-152 via a tunnel through intervening wired network nodes to configure and troubleshoot access points 151-152. Alternatively, wireless network nodes of the overlay enterprise network 100 can be configured and managed in a distributed fashion, similar to the wired network nodes as described above. That is, access points 151-152 can be individually configured and managed by the network administrator without interacting with WLAN controller 110.

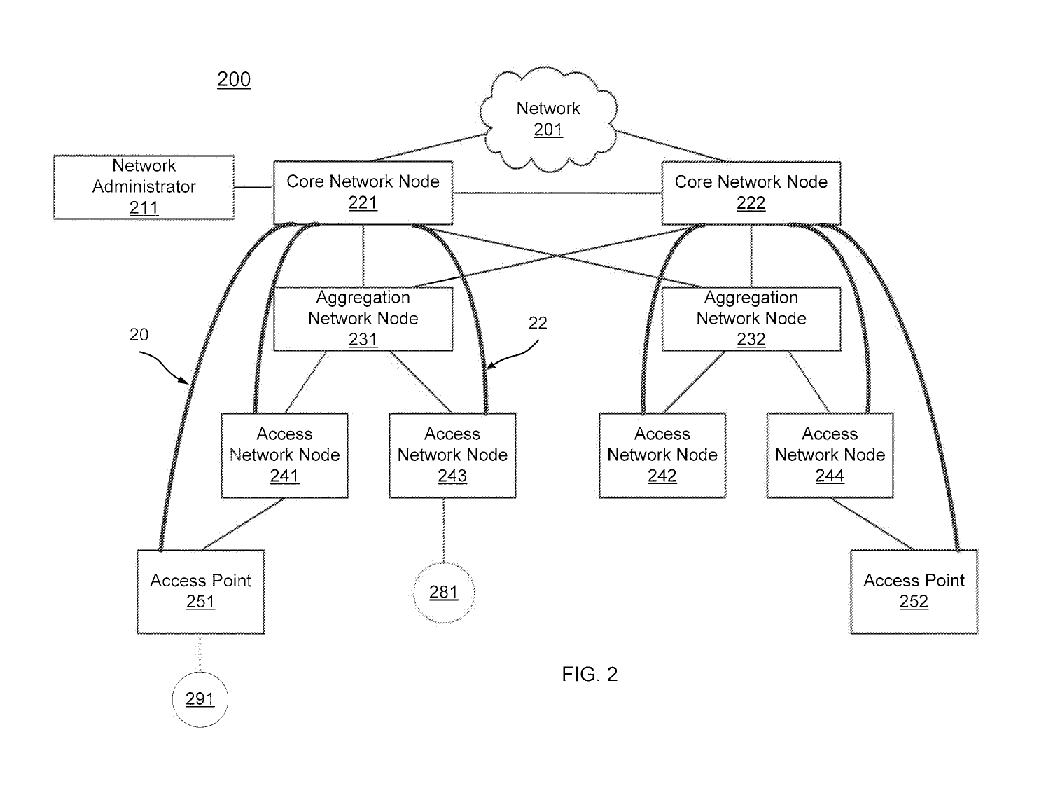

FIG. 2 is a schematic illustration of a homogeneous enterprise network 200 having access points (e.g., access point 251, access point 252), access network nodes (e.g., access network node 241-244), aggregation network nodes (e.g., aggregation network node 231, aggregation network node 232), core network nodes (e.g., core network node 221, core network node 222), and a network administrator 211, where the access points, access network nodes and aggregation network nodes are managed in a centralized fashion, according to an embodiment. Specifically, core network node 221 and core network node 222, with the assistance of network administrator 211, are configured to manage and configure each access point, access network node and aggregation network node within the homogeneous enterprise network 200. Similar to network 101 shown in FIG. 1, network 201 is a network coupled to the homogeneous enterprise network 200 through core network node 221 and/or core network node 222, which provides access to data resources, applications, and/or information services, to clients that are operatively coupled to the homogeneous enterprise network 200. For example, network 201 can be a data center network, a WAN, the Internet, etc.

In an enterprise network, if every network device included in the enterprise network or a portion of the enterprise network can be controlled by one or more core network nodes, then that enterprise network can be referred to as a homogeneous enterprise network, or that portion of the enterprise network can be referred to as a homogeneous portion of the enterprise network. In such a homogeneous network or portion of the network it is possible to use MPLS tunneling technology to tunnel traffic (e.g., wired or wireless traffic). If not every network node included in a portion of the enterprise network can be controlled by one or more core network nodes, then that portion of the enterprise network is referred to as an overlay enterprise network portion. Furthermore, an enterprise network including both a homogeneous portion and an overlay portion can be referred to as a heterogeneous enterprise network. Additionally, in some embodiments, one or more network devices included in a homogeneous portion or an overlay enterprise network portion of an enterprise network can tunnel traffic using a layer-3 tunneling technology (e.g., CAPWAP, Ethernet-in-GRE). MPLS tunneling technology can be used only in the homogeneous portion.

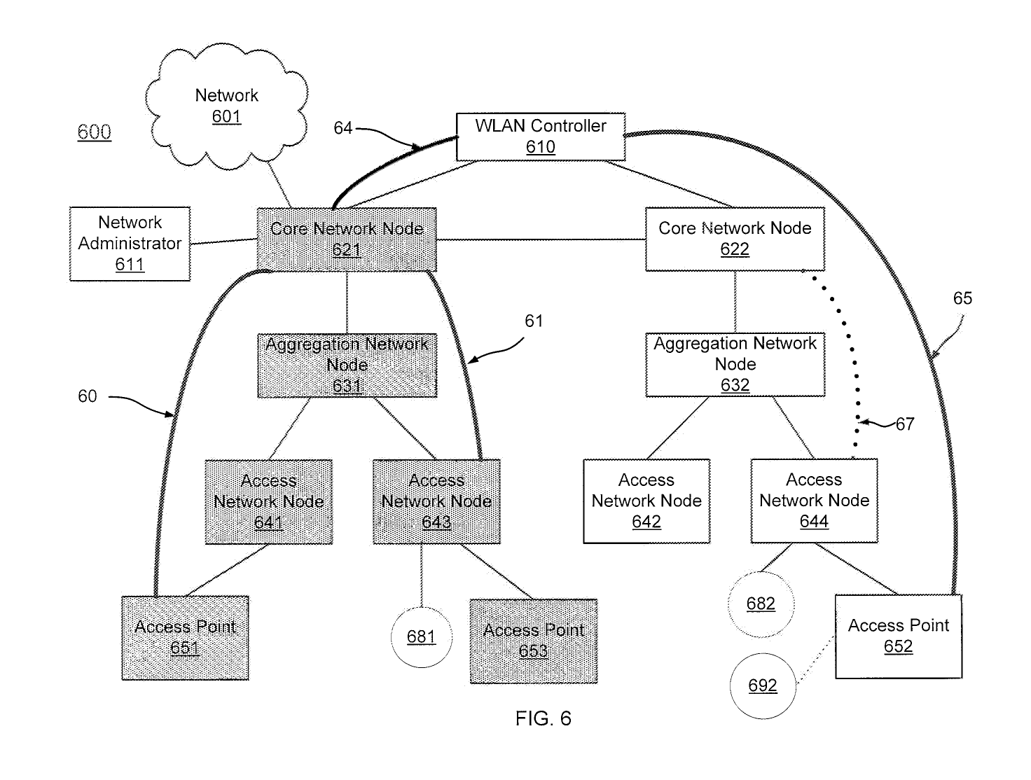

In a homogeneous enterprise network, a common tunneling technology can be used to forward both the wired traffic and the wireless traffic in any portion of the homogeneous enterprise network. For example, the MPLS tunneling technology or a layer-3 tunneling technology can be used to forward both the wired traffic and the wireless traffic in any portion of the homogeneous enterprise network 200. In contrast, as described above with respect to FIG. 1, in an overlay enterprise network (e.g., overlay enterprise network 100) a layer-3 tunneling technology can be used to forward the wireless traffic in the wireless overlay portion of the overlay enterprise network, while typically no tunneling technology (e.g., a layer-3 tunneling technology, the MPLS tunneling technology) is used to forward the wired traffic in the overlay enterprise network. On the other hand, in a heterogeneous enterprise network, different tunneling technologies may be used to forward wired or wireless traffic in different portions of the heterogeneous enterprise network, depending on the capabilities of network devices in specific portions of the heterogeneous enterprise network. For example, as described with respect to FIG. 6, the MPLS tunneling technology or a layer-3 tunneling technology can be used to forward both the wired traffic and the wireless traffic in a homogeneous portion of the heterogeneous enterprise network 600. A layer-3 tunneling technology (e.g., CAPWAP, Ethernet-in-GRE), but not the MPLS tunneling technology, can be used to forward the wireless traffic in an overlay enterprise network portion of the heterogeneous enterprise network 600. A layer-3 tunneling technology or no tunneling technology can be used to forward the wired traffic in the overlay enterprise network portion of the heterogeneous enterprise network 600 depending on the capabilities of the wired network nodes (e.g., core network nodes, aggregation network nodes, access network nodes) in the overlay enterprise network portion of the heterogeneous enterprise network 600. More detail related to the tunneling technologies used to forward wired and/or wireless traffic in an enterprise network is set forth in co-pending U.S. patent application Ser. No. ______ (Attorney Docket JUNI-095/00US 108200-2150), filed on the same date herewith, entitled, “Methods and Apparatus for a Converged Wired/Wireless Enterprise Network Architecture,” which is incorporated herein by reference in its entirety.

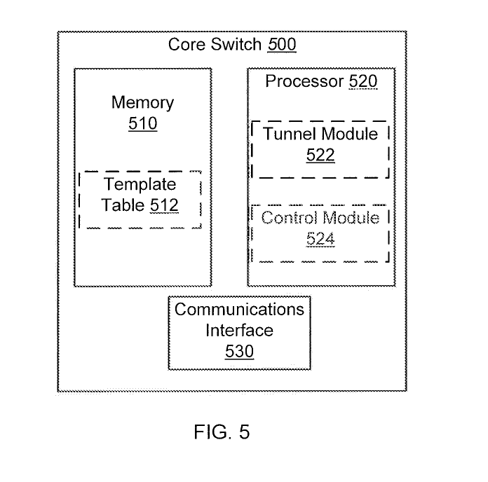

A core network node in a homogeneous enterprise network (e.g., core network node 221 or core network node 222 in the homogeneous enterprise network 200) can be, for example, upgraded from a core network node in an overlay enterprise network (e.g., core network node 121 or core network node 122 in the overlay enterprise network 100). In such an upgrade, the core network node (e.g., core network node 221, core network node 222) is a single device that combines a switch, a router, and a controller, which includes a control module (e.g., control module 524 for core network node 500 as shown in FIG. 5) configured to manage user sessions for both wired and wireless clients. In other words, core network node 221, 222 is a consolidation of a WLAN controller (e.g., WLAN controller 110) and a core network node from an overlay enterprise network. On one hand, similar to a core network node from an overlay enterprise network, core network node 221, 222 is still able to forward packets of wired sessions between an aggregation network node and a network that are operatively coupled to core network node 221, 222. On the other hand, unlike a core network node within an overlay enterprise network, core network node 221, 222 can establish a wired session with an access network node, or establish a wireless session with an access point, through intervening wired network nodes, via a tunnel (e.g., the MPLS tunnel, a layer-3 tunnel). In some embodiments, a core network node in a homogeneous enterprise network is referred to as a core SRC (switch, router, and controller).

Similar to core network nodes 221-222, all other devices in the homogeneous enterprise network 200, including aggregation network node 231-232, access network node 241-244, and access point 251-252, can be configured to operate in a homogeneous enterprise network. Specifically, the functionality of access network node 241-244 and aggregation network node 231-232 includes multiplexing client traffic, including packets of wired and wireless sessions, to core network node 221 or core network node 222 without any need for local switching or complex forwarding and classification functionality. For example, unlike aggregation network nodes 131-132 in overlay enterprise network 100, aggregation network node 231 does not need to be configured to switch or route a packet received from access network node 243 to another access network node based on a destination address included in the packet. Instead, aggregation network node 231 can be configured to forward the packet, through a portion of a tunnel between access network node 243 and core network node 221 (shown as the tunnel represented by 22 in FIG. 2), to core network node 221, from which the packet is further switched or routed to the destination. Similarly stated, access network nodes 241-244 are configured to transmit wired traffic to core network node 221 or core network node 222 via a tunnel (e.g., the tunnel represented by 22 in FIG. 2) through intervening aggregation network nodes 231-232. Access points 251-252 are configured to transmit wireless traffic to core network node 221 or core network node 222 via a tunnel (e.g., a tunnel represented by 20 in FIG. 2) through intervening access network nodes and aggregation network nodes.

A network administrator (e.g., network administrator 211) of a homogeneous enterprise network can be one or more persons responsible for the maintenance of the homogeneous enterprise network. The duties of a network administrator normally include deploying, configuring, maintaining and monitoring every network equipment in the homogeneous enterprise network, such as a core network node, a network node at the access layer or aggregation layer, a connection between two network nodes, etc. In some embodiments and depending on the context, network administrator 211 can represent a device used by a person to access, transmit instructions to, and receive monitor information from the core network nodes (e.g., core network node 221) of the homogeneous enterprise network 200, such that the network equipment of the homogeneous enterprise network 200 can be properly configured, monitored and maintained. In some other embodiments, network administrator 211 can represent a person who can directly operate on the core network nodes without using any extra device.

In an enterprise network, the tunneling technology applied between a core network node and an access device (e.g., an access network node, an access point) depends on the nature and/or capabilities of the core network node, the access device, and the intermediate network device(s) (e.g., aggregation network node) present between the core network node and the access device. Specifically, in an overlay enterprise network (e.g., overlay enterprise network 100), typically no tunneling protocol can be used between a core network node and an access device. In a homogeneous enterprise network (e.g., homogeneous enterprise network 200), a tunneling protocol such as MPLS or a layer-3 tunneling protocol can be used. In a heterogeneous enterprise network (e.g., the heterogeneous enterprise network 600 shown in FIG. 6), a tunneling protocol such as MPLS or a layer-3 tunneling protocol can be used in the homogenous portion of the heterogeneous enterprise network, while a layer-3 tunneling protocol or no tunneling protocol can be used in the overlay enterprise network portion of the heterogeneous enterprise network.

For example, if wireless user communication device 291 sends a packet to access point 251 destined to wired user communication device 281, the packet is first encapsulated according to the MPLS protocol or a layer-3 tunneling protocol at access point 251, and then transmitted to core network node 221 via a MPLS tunnel or a layer-3 tunnel through access network node 241 and aggregation network node 231 (shown as the tunnel represented by 20 in FIG. 2). Next, the encapsulated packet is decapsulated according to MPLS or the layer-3 tunneling protocol at core network node 221. Then, based on a destination IP address or a destination MAC address included in the packet, the packet is encapsulated again according to MPLS or a layer-3 protocol at core network node 221, and the encapsulated packet is forwarded by core network node 221 to access network node 243 via another MPLS tunnel or another layer-3 tunnel through aggregation network node 231 (shown as the tunnel represented by 22 in FIG. 2). Finally, the encapsulated packet is decapsulated according to MPLS or the layer-3 tunneling protocol at access network node 243, from which the decapsulated packet is delivered to wired user communication device 281.

For another example, if wired user communication device 281 sends a packet to access network node 243 destined to an IP address located in network 201, the packet is first encapsulated according to MPLS or a layer-3 tunneling protocol at access network node 243, and then transmitted to core network node 221 via a MPLS tunnel or a layer-3 tunnel through aggregation network node 231 (shown as the tunnel represented by 22 in FIG. 2). Next, the encapsulated packet is decapsulated according to MPLS or the layer-3 tunneling protocol at core network node 221. Finally, based on a destination IP address included in the packet, the decapsulated packet is forwarded by core network node 221 to network 201, and further delivered to the destination entity associated with the destination IP address in network 201.

In some embodiments, a centralized core architecture can provide a single point of configuration and management for services within the enterprise network as well as a single logic node of interaction for visibility and monitoring applications. As a result, various types of service modules can be aggregated and/or consolidated at one or more core network nodes, such as firewall, intrusion detection policy (IDP), virtual private network (VPN) termination, load balancing, etc. In such a homogeneous enterprise network, services no longer need to be distributed at various levels in the network, and users can be given consistent policy that is independent of their access mechanism.

In the homogeneous enterprise network 200, core network node 221 and core network node 222 can be configured to configure each network node at the access and aggregation layers, including access points 251-252, access network nodes 241-244 and aggregation network nodes 231-232. Specifically, after a network node is coupled to the homogeneous enterprise network 200, the network node is configured to send an initiation signal to a core network node operatively coupled to the network node. In response to receiving the initiation signal, the core network node is configured to define configuration information for the network node based on a template (e.g., stored in template table 512 shown in FIG. 5). The core network node is then configured to send the defined configuration information to the network node. Thus, the network node is configured accordingly based on the configuration information received from the core network node. In some embodiments, the configuration information is sent from the core network node to the network node via a tunnel through intervening wired network nodes, which is an in-band channel (e.g., a control channel within the data plane, a data plane tunnel and/or a data path) of the homogeneous enterprise network 200. In other words, the configuration information is sent from the core network node to the network node via an in-band channel through the same portion of the network as data and not through a separate management networks.

For example, after access network node 243 is coupled to the homogeneous enterprise network 200 (e.g., via aggregation network node 231), access network node 243 is configured to send an initiation signal to core network node 221 through aggregation network node 231, indicating the connection of access network node 243 to the homogeneous enterprise network 200. In response to receiving the initiation signal, core network node 221 is configured to define configuration information for access network node 243 based on a template. The configuration information defined for access network node 243 includes, for example, information that enables access network node 243 to establish communication channels with other network equipment, such as information associated with establishing a MPLS tunnel between access network node 243 and core network node 221 through aggregation network node 231, information associated with configuring the network interface parameters at access network node 243, etc. Next, core network node 221 is configured to send the configuration information defined for access network node 243 to access network node 243 via an in-band channel (e.g., a control channel within the data plane, a data plane tunnel and/or a data path). Upon receiving the configuration information, access network node 243 is configured accordingly by applying the configuration information.

In some embodiments, the configuration information sent from a core network node to a network node through an in-band channel excludes VLAN information or IP subnet information. Instead, after a user communication device (e.g., a wired user communication device, a wireless user communication device) is operatively coupled to a network node (e.g., an access network node, an access point), a core network node operatively coupled to the user communication device can be configured to send a control signal including VLAN information and/or IP subnet information to the user communication device through a control plane channel, such as a control plane tunnel, a control path, etc. The control plane channel is used to send control-related information, such as VLAN information or IP subnet information, and not data-plane packets or information. In other words, the control plane channel is not used to send any data-plane packets or information between the core network node and the user communication device.

For example, after wired user communication device 281 is operatively coupled to access network node 243, core network node 221 is configured to send a control signal including VLAN information associated with wired user communication device 281 to access network node 243 via a control plane tunnel through aggregation network node 231. The VLAN information is then forwarded from access network node 243 to wired user communication device 281. The control plane tunnel used to send the control signal is within the control plane of the homogeneous enterprise network 200, and different from the data plane tunnel used to send the configuration information from core network node 221 to access network node 243.

For another example, after wireless user communication device 291 is operatively coupled to access point 251, core network node 221 is configured to send a control signal including IP subnet information associated with wireless user communication device 291 to access point 251 through a control plane tunnel through aggregation network node 231 and access network node 241. The IP subnet information is then forwarded to wireless user communication device 291. The control plane tunnel used to send the control signal is within the control plane of the homogeneous enterprise network 200, and different from the data plane tunnel used to send the configuration information from core network node 221 to access point 251.

Although discussed in terms of VLAN information or IP subnet information, it should be understood that other types of control-related information can be included in a control signal(s) sent to a user communication device when the user communication device is operatively coupled to a network node.

In some embodiments, a network administrator operatively coupled to a core network node can send a configuration update signal to the core network node. In response to receiving the configuration update signal, the core network node can be configured to define configuration information for one or more network nodes based on one or more templates. The core network node is then configured to send each defined configuration information to the network node(s) through a data plane tunnel, respectively. Thus, the network node(s) are configured accordingly based on the received configuration information from the core network node.

For example, network administrator 211 can send a configuration update signal to core network node 221, instructing core network node 221 to update a template of configuration for aggregation network nodes in the homogeneous enterprise network 200. In response to receiving the configuration update signal, core network node 221 is configured to update the corresponding template, and then define configuration information for aggregation network node 231 and aggregation network node 232, respectively, based on the updated template. Next, core network node 221 can be configured to send the configuration information to aggregation network node 231 and aggregation network node 232 through two data plane tunnels, respectively. Alternatively, core network node 221 can be configured to send the configuration information defined for aggregation network node 231 to aggregation network node 231 through a data plane tunnel, and send the configuration information defined for aggregation network node 232 to core network node 222, from which the configuration information is forwarded to aggregation network node 232 through another data plane tunnel. Upon receiving the configuration information, aggregation network node 231 and aggregation network node 232 are configured accordingly by applying the respective configuration information.

In some embodiments, a core network node in a homogeneous enterprise network can be configured to define configuration information for a set of network nodes (e.g., access points, access network nodes, aggregation network nodes) based on a set of templates. In some embodiments, the set of templates can include a template for access network nodes, a template for aggregation network nodes, a template for access points, etc. For example, a core network node can be configured to define configuration information for two access network nodes based on a template for access network nodes, and define configuration information for an aggregation network node based on a template for aggregation network nodes that is different from the template for access network nodes. Furthermore, if the configuration information defined at a core network node for multiple network nodes is identical, the identical configuration information can be sent from the core network node to the multiple network nodes based on one or more multicast signals.

In the example of FIG. 2, core network node 221 can be configured to define configuration information for access network nodes 241-244 based on a first template for access network nodes; define configuration information for aggregation network nodes 231-232 based on a second template for aggregation network nodes; and define configuration information for access points 251-252 based on a third template for access points. As a result, the configuration information defined for access network node 241 may be identical to the configuration information defined for access network node 243. Thus, core network node 221 can be configured to send the identical configuration information to access network node 241 and access network node 243 based on a multicast signal. Specifically, the multicast signal containing the configuration information is sent from core network node 221 to aggregation network node 231, duplicated at aggregation network node 231, and then the two duplicated signals containing the configuration information are sent from aggregation network node 231 to access network node 241 and access network node 243, respectively.

In some embodiments, such a multicasting approach can be implemented with tunnels (e.g., data plane tunnels) between a core network node and multiple network nodes. For example, a multicast signal containing the configuration information for access network node 241 and access network node 243 is sent from core network node 221 to aggregation network node 231 through a portion of a data plane tunnel between core network node 221 and access network node 241 (or, equivalently, a portion of a data plane tunnel between core network node 221 and access network node 243). The multicast signal is duplicated at aggregation network node 231 based on an identifier (e.g., a multicasting identifier) included in the multicast signal. The duplicated signals are then sent from aggregation network node 231 to access network node 241 and access network node 243 through the remaining portion of the two data plane tunnels, respectively. Thus, the configuration information is sent from core network node 221 to access network node 241 and access network node 243 through the data plane tunnels, while only one multicast signal is sent from core network node 221 to aggregation network node 231.

In the homogeneous enterprise network 200, core network node 221 and/or core network node 222 can be configured to monitor and troubleshoot each network node at the access and aggregation layers, including access points 251-252, access network nodes 241-244 and aggregation network nodes 231-232. Specifically, core network node 221 and/or core network node 222 can be configured to receive monitor information from access points 251-252, access network nodes 241-244 and aggregation network nodes 231-232. The monitor information can be any data collected or generated at a network node that is associated with an operational status of the network node and/or any other network node, such as a number of data packets travelling through the network node in a certain period of time, a timestamp when a user communication device is connected to or disconnected from the network node, etc.

Upon receiving the monitor information from each network node, core network node 221 and/or core network node 222 can be configured to determine (if any exist) one or more malfunctioning or problematic network nodes by analyzing the monitor information received from each network node, and/or comparing the monitor information received from each network node to the monitor information received from its adjacent network nodes. Next, core network node 221 and/or core network node 222 can be configured to send a troubleshoot signal to each malfunctioning network node, such that a troubleshooting procedure can be operated on each malfunctioning network node, respectively. In some embodiments, the monitor information sent from each network node to core network node 221 and/or core network node 222 and the troubleshoot signal(s) sent from core network node 221 and/or core network node 222 to the malfunctioning network node(s) are all through the control plane of the homogeneous enterprise network 200. That is, the monitor information and the troubleshoot signals are sent through control plane tunnels and/or control paths that are not used for transmitting any data-plane packets or information.

For example, upon receiving the monitor information from each network node in the homogeneous enterprise network 200 through control plane tunnels and/or control paths, core network node 221 can determine that access point 251 is not able to receive any data-plane tunneled packet sent from core network node 221 through a data plane MPLS tunnel (e.g., the tunnel represented by 20 in FIG. 2), based on comparing the monitor information sent from access point 251 and access network node 241. Subsequently, core network node 221 is configured to send a troubleshoot signal to access point 251 through a control path (not shown in FIG. 2), which contains information associated with reestablishing a data plane MPLS tunnel between access point 251 and core network node 221. As a result of receiving the troubleshoot signal, access point 251 is configured to go through a troubleshooting procedure, including reestablishing a data plane MPLS tunnel between access point 251 and core network node 221.

In some embodiments, a network node in a homogeneous enterprise network can be troubleshot by one or more core network nodes of the homogeneous enterprise network only. In other words, other than the troubleshoot signal(s) received from the core network node(s), the network node does not receive any other troubleshoot signal originated from another network node. In the example of FIG. 2, aggregation network nodes 231-232, access network nodes 241-244 and access points 251-252 receive troubleshoot signals from core network node 221 and/or core network node 222 only, but not from any other network node in the homogeneous enterprise network 200.

In some embodiments, after receiving monitor information from each network node from the set of network nodes in a homogeneous enterprise network, a core network node can be configured to produce integrated monitor information based on the monitor information received from each network node. The integrated monitor information can be, for example, a snapshot of the operational status of each network node from the set of network nodes, a summary of the number of data packets received at and/or sent from each network node from the set of network nodes, a summary of the number of data packets dropped at each network node, etc. Furthermore, the core network node can be configured to output a representation of the integrated monitor information to a network administrator operatively coupled to the core network node. A representation of the integrated monitor information can be, for example, a list of malfunctioning network nodes, a summary of network links that carry the most data packets in the homogeneous enterprise network during a certain period of time, etc.

In the example of FIG. 2, after receiving monitor information from aggregation network nodes 231-232, access network nodes 241-244 and access points 251-252, core network node 221 and/or core network node 222 are configured to produce integrated monitor information including, for example, a summary of the number of data packets dropped at each network node. Based on such integrated monitor information, core network node 221 and/or core network node 222 are configured to output a representation of the integrated monitor information to network administrator 211. This representation can include, for example, a list of malfunctioning network nodes that are inferred from the number of data packets dropped at each network node. Thus, network administrator 211 can be guided to look into the problem (e.g., follow up on the troubleshooting operation for each malfunctioning network node) accordingly based on the representation of the integrated monitor information received from core network node 221 and/or core network node 222.

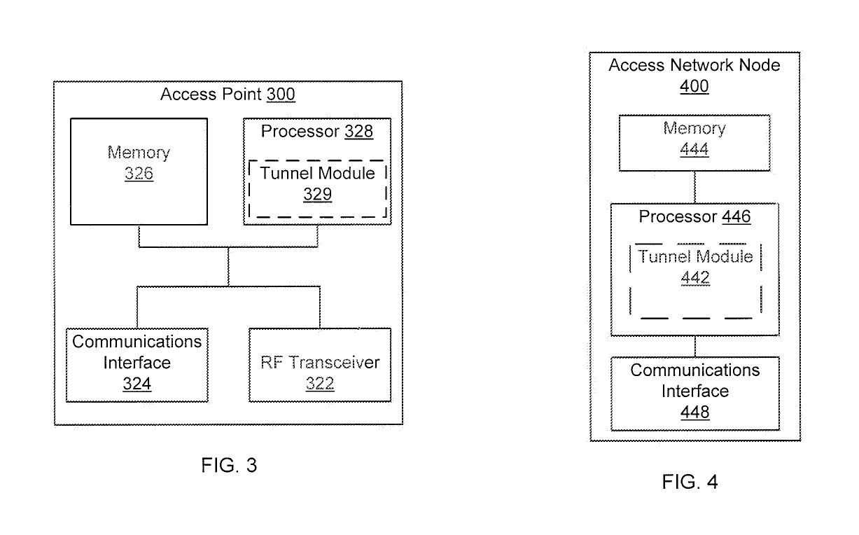

FIG. 3 is a system block diagram of an access point 300, according to an embodiment. Similar to access point 251 and access point 252 in the homogeneous enterprise network 200 shown in FIG. 2, access point 300 can be any device that connects one or more wireless user communication devices to a homogeneous enterprise network (e.g., via an access network node) using for example, Wi-Fi, Bluetooth or other wireless communication standards. For example, access point 300 can be a wireless access point (WAP). As shown in FIG. 3, access point 300 includes RF transceiver 322, communications interface 324, memory 326, and processor 328, which contains tunnel module 329. Each component of access point 300 is operatively coupled to each of the remaining components of access point 300. Each component of access point 300 is operatively coupled to each of the remaining components of access point 300. Furthermore, each operation of RF transceiver 322 (e.g., transmit/receive data), communications interface 324 (e.g., transmit/receive data), tunnel module 329 (e.g., encapsulate/decapsulate packets), as well as each manipulation on memory 326 (e.g., update a policy table), are controlled by processor 328.

In some embodiments, access point 300 can communicate with a wireless user communication device (e.g., a Wi-Fi enabled laptop, a mobile phone) using any suitable wireless communication standard such as, for example, Wi-Fi, Bluetooth, and/or the like. Specifically, access point 300 can be configured to receive data and/or send data through RF transceiver 322, when communicating with a wireless user communication device. Furthermore, in some embodiments, an access point of an enterprise network uses one wireless communication standard to wirelessly communicate with a wireless user communication device operatively coupled to the access point; while another access point of the enterprise network uses a different wireless communication standard to wirelessly communicate with a wireless user communication device operatively coupled to the other access point. For example, as shown in FIG. 2, access point 251 can receive data packets through its RF transceiver from wireless user communication device 291 (e.g., a Wi-Fi enabled laptop) based on the Wi-Fi standard; while access point 252 can send data packets from its RF transceiver to another wireless user communication device (e.g., a Bluetooth-enabled mobile phone) (not shown in FIG. 2) based on the Bluetooth standard.

In some embodiments, access point 300 can be operatively coupled to an access network node by implementing a wired connection between communications interface 324 and the counterpart (e.g., a communications interface) of the access network node. The wired connection can be, for example, twisted-pair electrical signaling via electrical cables, fiber-optic signaling via fiber-optic cables, and/or the like. As such, access point 300 can be configured to receive data and/or send data through communications interface 324, which is connected with the communications interface of an access network node, when access point 300 is communicating with the access network node. Furthermore, in some embodiments, an access point of an enterprise network implements a wired connection with an access network node operatively coupled to the access point; while another access point of the enterprise network implements a different wired connection with an access network node operatively coupled to the other access point. For example, as shown in FIG. 2, access point 251 can implement one wired connection such as twisted-pair electrical signaling to connect with access network node 241; while access point 252 can implement a different wired connection such as fiber-optic signaling to connect with access network node 244.

Although not explicitly shown in FIG. 2, it should be understood that an access point 300 can be connected to one or more other access points, which in turn, can be coupled to yet one or more other access points. In such an embodiment, the collection of interconnected access points can define a wireless mesh network within the homogenous enterprise network 200. In such an embodiment, the communications interface 324 of access point 300 can be used to implement a wireless connection(s) to the counterpart (e.g., a communications interface) of another access point(s). As such, access point 300 can be configured to receive data and/or send data through communications interface 324, which is connected with the communications interface of another access point, when access point 300 is communicating with that access point.

In some embodiments, as described with respect to FIG. 2, access point 300 can be configured to prepare a packet (e.g., a data packet, a control packet) received from a wireless user communication device operatively coupled to access point 300, and send the packet to another network device such as a core network node via a tunnel (e.g., a layer-3 tunnel, a MPLS tunnel). Access point 300 can also be configured to decapsulate a packet received via a tunnel from another network device such as a core network node, before forwarding the decapsulated packet to a wireless user communication device operatively coupled to access point 300. Specifically, upon receiving a packet from a wireless user communication device operatively coupled to access point 300, tunnel module 329 is configured to encapsulate the packet (e.g., add a header portion, a footer portion, and/or modify any other identifiers included within the packet) according to a predetermined tunneling protocol (e.g., CAPWAP, Ethernet-in-GRE, MPLS). The encapsulated packet is then sent through communications interface 324 to an access network node connected to access point 300, from which the encapsulated packet is forwarded along the tunnel to a network device at the end of the tunnel. On the other hand, upon receiving a packet from an access network node connected to access point 300 that is sent through a tunnel from a network device, tunnel module 329 is configured to decapsulate the packet (e.g., remove a header portion, a footer portion, and/or modify any other identifiers included within the packet) according to a predetermined tunneling protocol (e.g., CAPWAP, Ethernet-in-GRE, MPLS). The decapsulated packet is then sent by RF transceiver 322 to a wireless user communication device operatively coupled to access point 300.

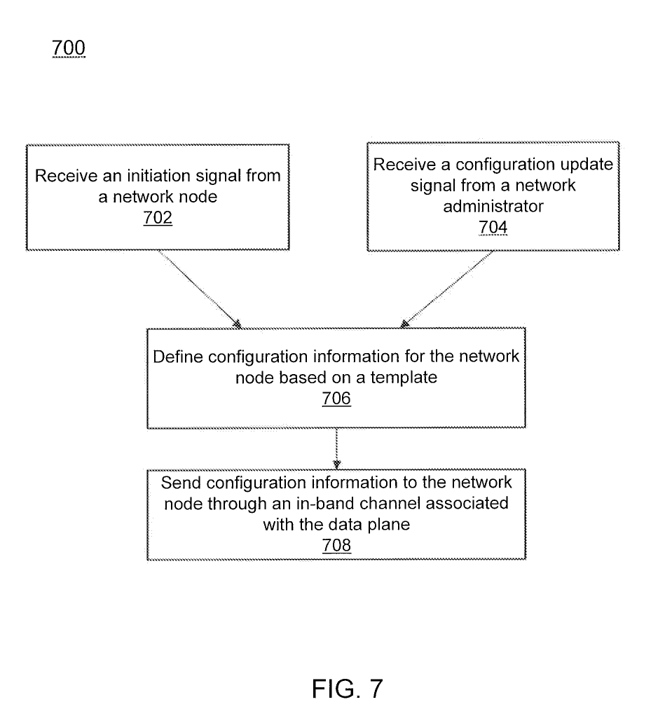

In some embodiments, as described with respect to FIG. 2, when the network device (e.g., a core network node) at the end of the tunnel and all the intervening wired network nodes (e.g., access network nodes, aggregation network nodes) are within a homogeneous enterprise network or a homogeneous portion of a heterogeneous enterprise network, tunnel module 329 can be configured to encapsulate or decapsulate a packet according to a tunneling protocol such as MPLS or a layer-3 tunneling protocol. In such embodiments, access point 300 can be configured to send a packet to and/or receive a packet from a core network node via a tunnel such as a MPLS tunnel or a layer-3 tunnel through intervening wired network nodes. In some other embodiments, as described below with respect to FIG. 7, when one or more of the network devices at the end of the tunnel and intervening wired network nodes are within an overlay enterprise network portion of a heterogeneous enterprise network, tunnel module 329 may be configured to encapsulate or decapsulate a packet, for example, according to a layer-3 tunneling protocol (e.g., CAPWAP, Ethernet-in-GRE). In such embodiments, access point 300 may be configured to send a packet to and/or receive a packet from a core network node via a layer-3 tunnel through the intervening wired network nodes.

In some embodiments, memory 326 can be, for example, a random-access memory (RAM) (e.g., a dynamic RAM, a static RAM), a flash memory, a removable memory, and/or so forth. In some embodiments, data related to operations of access point 300 can be stored in memory 326. For example, an up-link policy table (not shown in FIG. 3) can be stored in memory 326, such that one or more up-link policies associated with a user can be downloaded to and enforced at access point 300 when the user is operatively coupled to access point 300 using a wireless user communication device. For another example, information associated with tunneling packets to a core network node can be stored in memory 326, such that establishing a tunnel such as a MPLS tunnel or a layer-3 tunnel with the core network node can be initialized by access point 300.

Similar to the access points in the homogeneous enterprise network 200 described above with respect to FIG. 2, access point 300 can be managed and configured by one or more core network nodes operatively coupled to access point 300 in a homogeneous enterprise network (e.g., the homogeneous enterprise network 200 in FIG. 2). Specifically, after access point 300 is operatively coupled to a homogeneous enterprise network, processor 328 is configured to send an initiation signal through communications interface 324 to a core network node operatively coupled to access point 300. Later, access point 300 is configured to receive configuration information defined by and sent from the core network node through communication interface 324, and then store the configuration information in memory 326. Particularly, the received configuration information excludes VLAN information or IP subnet information, and is received via an in-band channel of the homogeneous enterprise network, such as a data plane tunnel, a data path, etc. Thus, access point 300 is configured accordingly based on the received configuration information such that access point 300 is configured to operate appropriately as a network node in the homogeneous enterprise network. Additionally, in some embodiments, access point 300 can be configured to receive control-related information such as VLAN information and/or IP subnet information via a control channel (e.g., a control plane tunnel, a control path) from the core network node.

Similar to the access points in the homogeneous enterprise network 200 described above with respect to FIG. 2, access point 300 can also be monitored and troubleshot by one or more core network nodes operatively coupled to access point 300 in a homogeneous enterprise network. Specifically, access point 300 can be configured to send monitor information, through communications interface 324, to a core network node operatively coupled to access point 300. The monitor information can include data collected or generated by access point 300 that is associated with the operational status of access point 300 and/or any other neighboring network node. As a result of reporting monitor information to the core network node, access point 300 may receive a troubleshoot signal from the core network node through communications interface 324. Thus, access point 300 is configured to go through a troubleshooting procedure based on the received troubleshoot signal. In some embodiments, both the monitor information and the troubleshoot signal are sent over a control channel (e.g., a control plane tunnel, a control path) in the homogeneous enterprise network.

FIG. 4 is a system block diagram of an access network node 400, according to an embodiment. Similar to access network node 241-244 in the homogeneous enterprise network 200 shown in FIG. 2, access network node 400 can be any device that connects one or more wired user communication devices to a homogeneous enterprise network, such as a hub, an Ethernet switch, etc. More specifically, access network node 400 is configured to ensure packets are transmitted between one or more aggregation network nodes, wired user communication devices, and/or access points that are operatively coupled to access network node 400. As shown in FIG. 4, access network node 400 includes communications interface 448, memory 444, and processor 446, which contains tunnel module 442. Each component of access network node 400 is operatively coupled to each of the remaining components of access network node 400. Furthermore, each operation of communications interface 448 (e.g., transmit/receive data), tunnel module 442 (e.g., encapsulate/decapsulate packets), as well as each manipulation on memory 444 (e.g., update a policy table), are controlled by processor 446.

In some embodiments, communications interface 448 of access network node 400 includes at least two ports (not shown in FIG. 4) that can be used to implement one or more wired connections between access network node 400 and one or more access points, wired user communication devices, and/or aggregation network nodes. The wired connection can be, for example, twisted-pair electrical signaling via electrical cables, fiber-optic signaling via fiber-optic cables, and/or the like. As such, access network node 400 can be configured to receive data and/or send data through one or more ports of communications interface 448, which are connected to the communications interfaces of one or more access points, wired user communication devices, and/or aggregation network nodes. Furthermore, in some embodiments, access network node 400 can implement a wired connection with one of an access point, a wired user communication device, or an aggregation network node that is operatively coupled to access network node 400 through one port of communications interface 448, while implementing a different wired connection with another access point, wired user communication device, or aggregation network node that is operatively coupled to access network node 400 through another port of communications interface 448. For example, as shown in FIG. 2, access network node 241 can implement one wired connection such as twisted-pair electrical signaling to connect with access point 251, while implementing a different wired connection such as fiber-optic signaling to connect with aggregation network node 231.

In some embodiments, as described with respect to FIG. 2 and FIG. 3, access network node 400 can be one of the intervening wired network nodes between an access point and a core network node, through which a tunnel (e.g., a layer-3 tunnel, a MPLS tunnel) is established between the access point and the core network node. In such embodiments, access network node 400 can be configured to forward a tunneled packet (e.g., a packet encapsulated according to a layer-3 tunneling protocol, a packet encapsulated according to MPLS). For example, as shown in FIG. 2, access network node 241 can forward a tunneled packet encapsulated according to MPLS or a layer-3 tunneling protocol, which is received from access point 251, to aggregation network node 231 along a MPLS tunnel or a layer-3 tunnel (shown as the tunnel represented by 20 in FIG. 2) between access point 251 and core network node 221.

In some embodiments, as described with respect to FIG. 2, access network node 400 can be configured to prepare a packet (e.g., a data packet, a control packet) received from a wired user communication device operatively coupled to access network node 400, and send the packet to another network device such as a core network node via a tunnel (e.g., a tunnel according to a layer-3 tunneling protocol (e.g., Ethernet-in-GRE, CAPWAP, etc.) or the MPLS protocol). Access network node 400 can also be configured to decapsulate a packet received via a tunnel from another network device such as a core network node, before forwarding the decapsulated packet to a wired user communication device operatively coupled to access network node 400. Specifically, upon receiving a packet from a wired user communication device operatively coupled to access network node 400, tunnel module 442 is configured to encapsulate the packet (e.g., add a header portion, a footer portion, and/or modify any other identifiers included within the packet) according to the protocol of the tunnel. The encapsulated packet is then sent through a port of communications interface 448 to an aggregation network node connected to access network node 400, from which the encapsulated packet is forwarded along the tunnel to a core network node. On the other hand, upon receiving a packet from an aggregation network node connected to access network node 400 that is sent through a tunnel from a core network node, tunnel module 442 is configured to decapsulate the packet (e.g., remove a header portion, a footer portion, and/or modify any other identifiers included within the packet) according to the protocol of the tunnel. The decapsulated packet is then sent through a port of communications interface 448 to a wired user communication device operatively coupled to access network node 400.

In some embodiments, memory 444 can be, for example, a random-access memory (RAM) (e.g., a dynamic RAM, a static RAM), a flash memory, a removable memory, and/or so forth. In some embodiments, data other than up-link policies that is related to operations of access network node 400 can also be stored in memory 444. For example, MAC addresses of potential user communication devices can be stored in memory 444, such that a user communication device can be recognized by access network node 400 upon being operatively coupled to access network node 400. For another example, information associated with tunneling packets to a core network node can be stored in memory 444, such that establishing a MPLS tunnel or a layer-3 tunnel with the core network node can be initialized by access network node 400.

Similar to access point 300, access network node 400 can be managed and configured by one or more core network nodes operatively coupled to access network node 400 in a homogeneous enterprise network (e.g., the homogeneous enterprise network 200 in FIG. 2). Specifically, after access network node 400 is operatively coupled to a homogeneous enterprise network, processor 446 is configured to send an initiation signal through communications interface 448 to a core network node operatively coupled to access network node 400. Later, access network node 400 is configured to receive configuration information defined by and sent from the core network node through communication interface 448, and then store the configuration information in memory 444. Particularly, the received configuration information excludes VLAN information or IP subnet information, and is received via an in-band channel (e.g., a control channel within the data plane, a data plane tunnel and/or a data path) of the homogeneous enterprise network. In other words, the configuration information is sent via an in-band channel through the same portion of the network as data and not through a separate management networks.

Thus, access network node 400 is configured accordingly based on the received configuration information such that access network node 400 is configured to operate appropriately as a network node in the homogeneous enterprise network. Additionally, in some embodiments, access network node 400 can be configured to receive VLAN information and/or IP subnet information via a control channel (e.g., a control plane tunnel, a control path) from the core network node.

Similar to access point 300, access network node 400 can also be monitored and troubleshot by one or more core network nodes operatively coupled to access network node 400 in a homogeneous enterprise network. Specifically, access network node 400 can be configured to send monitor information, through communications interface 448, to a core network node operatively coupled to access network node 400. The monitor information can include data collected or generated by access network node 400 that is associated with the operational status of access network node 400 and/or any other neighboring network node. As a result of reporting monitor information to the core network node, access network node 400 can receive a troubleshoot signal from the core network node through communications interface 448. Thus, access network node 400 is configured to go through a troubleshooting procedure based on the received troubleshoot signal. In some embodiments, both the monitor information and the troubleshoot signal are sent over a control channel (e.g., a control plane tunnel, a control path) in the homogeneous enterprise network.

FIG. 5 is a system block diagram of a core network node 500, according to an embodiment. Similar to core network node 221 and core network node 222 in the homogeneous enterprise network 200 shown in FIG. 2, core network node 500 can be any switching device positioned in the physical core, or backbone, of an enterprise network, which is configured to operatively couple the remaining devices (e.g., aggregation network nodes, access network nodes, access points) of the enterprise network to one or more other networks that provide access to data resources and/or information services. More specifically, core network node 500 is configured, for example, to forward data between one or more aggregation network nodes and one or more other networks that are operatively coupled to core network node 500, based on IP routing or switching services. Furthermore, core network node 500 is configured, for example, to manage user sessions for both wired and wireless clients, configure and manage each network node operatively coupled to core network node 500 in the enterprise network, monitor the operation of the network nodes and troubleshoot any malfunctioning network node if necessary, as described in detail herein.

As shown in FIG. 5, core network node 500 includes communications interface 530; memory 510, which contains template table 512; and processor 520, which contains tunnel module 522 and control module 524. Each operation of communications interface 530 (e.g., transmit/receive data), tunnel module 522 (e.g., encapsulate/decapsulate packets), and control module 524 (e.g., manage a user session), as well as each manipulation on template table 512 (e.g., update a template) or any other portion of memory 510, are controlled by processor 520.

In some embodiments, communications interface 530 of core network node 500 includes at least two ports (not shown in FIG. 5) that can be used to implement one or more wired connections between core network node 500 and one or more aggregation network nodes, one or more access network nodes, other core network nodes, and/or devices of other networks. The wired connections can be, for example, twisted-pair electrical signaling via electrical cables, fiber-optic signaling via fiber-optic cables, and/or the like. As such, core network node 500 can be configured to receive data and/or send data through one or more ports of communications interface 530, which are connected with the communications interfaces of one or more aggregation network nodes, one or more access network nodes, other core network nodes, and/or devices of other networks. Furthermore, in some embodiments, core network node 500 can implement a wired connection with one of an aggregation network node, an access network node, another core network node, or a device of another network that is operatively coupled to core network node 500 through one port of communications interface 530, while implementing a different wired connection with another aggregation network node, access network node, core network node, or device of another network that is operatively coupled to core network node 500 through another port of communications interface 530. For example, as shown in FIG. 2, core network node 221 can implement one wired connection such as twisted-pair electrical signaling to connect with aggregation network node 231, aggregation 232 and core network node 222, while implementing a different wired connection such as fiber-optic signaling to connect with a device of network 201.

In some embodiments, as described with respect to FIG. 2, core network node 500 can be configured to prepare a packet (e.g., a data packet, a control packet) to be sent to an access device (e.g., an access point, an access network node) via a tunnel (e.g., a tunnel according to a layer-3 tunneling protocol (e.g., Ethernet-in-GRE, CAPWAP, etc.) or the MPLS protocol). Core network node 500 can also be configured to receive and decapsulate an encapsulated packet from an access device via a tunnel. Similar to core network nodes in the overlay enterprise network 100 shown in FIG. 1, core network node 500 can be configured to forward packets to and/or receive packets from other network devices that are operatively coupled to core network node 500, including other core network nodes and/or devices in other networks, without using any tunneling technology. Particularly, control module 524 of core network node 500 is configured to manage both wired and wireless user sessions for one or more users and/or for one or more user communication devices.

More specifically, upon receiving a packet associated with a user session at a port of communications interface 530 via a tunnel (e.g., a tunnel according to a layer-3 tunneling protocol or the MPLS protocol), tunnel module 522 is configured to decapsulate the packet (e.g., remove a header portion, a footer portion, and/or modify any other identifiers included within the packet) according to the protocol for that tunnel. Alternatively, core network node 500 receives a packet associated with a user session at a port of communications interface 530 from another network device operatively coupled to core network node 500, such as another core network node or a device in another network. To forward the received packet, control module 524 is configured to check the destination IP address or destination MAC address included in the packet. If the packet is not destined to a user in a pod that is directly connected to core network node 500 (e.g., destined to a network device in a pod that is not connected to core network node 500, destined to a user in another network), control module 524 is configured to forward the packet, from a port of communications interface 530, to a network device that is operatively coupled to core network node 500, such as another core network node or a device in another network, without using any tunneling technology. If the packet is destined to a user in a pod that is directly connected to core network node 500, tunnel module 522 is configured to encapsulate the packet (e.g., add a header portion, a footer portion, and/or modify any other identifiers included within the packet) according to the protocol for a tunnel. Meanwhile, control module 524 is configured to establish a tunnel connecting core network node 500 to the access device (e.g., an access network node, an access point) that is operatively coupled to the user communication device (if such a tunnel is not established yet). Finally, control module 524 is configured to send the encapsulated packet, from a port of communications interface 530, to the access device through that tunnel.

As described with respect to FIG. 2 and shown in FIG. 5, one or more templates associated with defining configuration information for one or more network nodes are stored in template table 512, which is located and maintained within a portion of memory 510 in core network node 500. As described with respect to FIG. 2, multiple templates can be stored in template table 512, each of which can be used to define configuration information for one network node or a group of network nodes of the same type. For example, the templates stored in template table 512 can include a template for access network nodes, a template for aggregation network nodes, a template for access points, etc.

Similar to the core network nodes described with respect to FIG. 2, core network node 500 can be configured to define configuration information for a network node based on a template stored in template table 512. For example, upon receiving an initiation signal from a network node (e.g., an access network node) operatively coupled to core network node 500, core network node 500 is configured to retrieve a corresponding template that is appropriate for the network node (e.g., a template for access network nodes) from template table 512. Core network node 500 is then configured to define configuration information for the network node based on the retrieved template accordingly. Furthermore, core network node 500 is configured to send the defined configuration information to the network node through a data channel (e.g., a data plane tunnel, a data path). Thus, the network node is configured accordingly based on the configuration information received from core network node 500.

Alternatively, for another example, core network node 500 receives a configuration update signal from a network administrator operatively coupled to core network node 500. The configuration update signal is sent to instruct core network node 500 to update a template stored in template table 512 that is associated with configuration information for a group of network nodes (e.g., access points). In response to receiving the configuration update signal, core network node 500 is configured to update the template accordingly based on the received configuration update signal. As a result, core network node 500 is configured to redefine configuration information for each network node from the group of network nodes based on the updated template. Subsequently, core network node 500 is configured to send the redefined configuration information to each network node from the group of network nodes through a data channel, respectively.

In some embodiments, core network node 500 can be configured to modify (e.g., add, delete, update) one or more templates stored in template table 512 in memory 510. For example, as described herein, core network node 500 can be configured to modify a template stored in template table 512 based on a configuration update signal received from a network administrator (e.g., network administrator 211 in FIG. 2) that instructs core network node 500 to update the template. For another example, core network node 500 can be configured to add a new template into template table 512 in response to receiving an instruction signal from a network administrator, such that the new template can be used by core network node 500 to, for example, define configuration information for a new type of network devices that are newly coupled to the enterprise network. In addition, in some embodiments, a network administrator operatively coupled to core network node 500 can access template table 512 to modify (e.g., add, delete, update) one or more templates stored in template table 512.

In some embodiments, memory 510 can be, for example, a random-access memory (RAM) (e.g., a dynamic RAM, a static RAM), a flash memory, a removable memory, and/or so forth. In some embodiments, data other than templates that is related to operations of core network node 500 can also be stored in memory 510. For example, combinations of user IDs and passwords of potential users can be stored in memory 510, such that the identification of a user can be verified by core network node 500 upon a user ID and a password entered by the user being provided to core network node 500. For another example, information associated with tunneling packets to one or more access devices can be stored in memory 510, such that establishing a MPLS tunnel or a layer-3 tunnel with one of the access devices can be initialized by core network node 500.

FIG. 6 is a schematic illustration of a heterogeneous enterprise network 600 having access points (e.g., access points 651-653), access network nodes (e.g., access network nodes 641-644), aggregation network nodes (e.g., aggregation network node 631, aggregation network node 632), core network nodes (e.g., core network node 621, core network node 622), and a WLAN controller 610, according to an embodiment. In this example, among the network devices, access point 651, access point 653, access network node 641, access network node 643, aggregation network node 631, and core network node 621 are network devices similar to those within a homogeneous enterprise network (e.g., the network devices in the homogeneous enterprise network 200 described with respect to FIG. 2), as identified by shaded boxes in FIG. 6. The left side of the FIG. 6 with the shaded network devices comprise the homogeneous portion of the heterogeneous enterprise network 600. On the other hand, other network devices of the heterogeneous enterprise network 600, including access point 652, access network node 642, access network node 644, aggregation network node 632, core network node 622, and WLAN controller 610 comprise the wireless overlay enterprise network portion of the heterogeneous enterprise network 600. Specifically, some or all of those network devices are similar to the network devices within an wireless overlay enterprise network (e.g., the network devices in overlay enterprise network 100 described with respect to FIG. 1). Additionally, network administrator 611 is a network administrator similar to network administrator 211 described with respect to FIG. 2.

As described herein, the tunneling technology applied between two network devices (e.g., access points, access network nodes, aggregation network nodes, core network nodes, WLAN controllers) in an enterprise network depends on the nature and/or capabilities of the two network devices and the intermediate network devices present between the two network devices. Specifically, if not all of the two network devices and the intermediate network devices present between the two network devices are capable of using MPLS, then a layer-3 tunneling protocol (e.g., CAPWAP, Ethernet-in-GRE) can be applied, while MPLS will not be applied, for the tunnel between the two network devices. On the other hand, if all of the two network devices and the intermediate network devices present between the two network devices are capable of using the MPLS, or in other words, operating like the devices in a homogeneous enterprise network, then either a layer-3 tunneling protocol or MPLS can be applied for the tunnel between the two network devices.

As described in detail herein, a core network node (e.g., core network node 621) within a homogeneous portion of a heterogeneous enterprise network can be configured to manage wired/wireless network devices and/or wired/wireless sessions within the homogeneous portion of the heterogeneous enterprise network. In contrast, a core network node (e.g., core network node 622) within an overlay enterprise network portion of a heterogeneous enterprise network, which operates like a core network node in a wireless overlay enterprise network (e.g., core network node 121 or 122 in overlay enterprise network 100 in FIG. 1), can be configured to manage wired sessions only, but not wireless sessions. For a wireless overlay enterprise network portion that does not include any core network node operating like a core network node in a homogeneous enterprise network, a WLAN controller (e.g., WLAN controller 610) can be used to manage wireless network nodes and/or wireless sessions. That is, wireless traffic generated from access points within such a wireless overlay enterprise network portion is tunneled to the WLAN controller via a layer-3 tunnel before it is forwarded to the destination by the WLAN controller.

In some embodiments, more than one type of tunneling technologies can be used in a homogeneous portion of a heterogeneous enterprise network. For example, as shown in FIG. 6, both layer-3 tunnels and MPLS tunnels can be used to forward wired and/or wireless traffic in the homogeneous portion of the heterogeneous enterprise network 600. To be specific, a layer-3 tunnel (e.g., a CAPWAP tunnel, an Ethernet-in-GRE tunnel) can be used to forward wireless traffic between access point 651 and core network node 621 (shown as the tunnel represented by 60 in FIG. 6). Alternatively, a MPLS tunnel can also be used to forward wireless traffic between access point 651 and core network node 621. Meanwhile, a MPLS tunnel can be used to forward wired traffic between access network node 643 and core network node 621 (shown as the tunnel represented by 61 in FIG. 6). Alternatively, a layer-3 tunnel can also be used to forward wired traffic between access network node 643 and core network node 621. Although not shown in FIG. 6, other tunnels (e.g., layer-3 tunnels, MPLS tunnels) also can be used between network devices in the homogeneous portion of the heterogeneous enterprise network 600.

In some embodiments, a controller-to-controller tunnel can be used to connect a WLAN controller with a controller (e.g., a control module) of a core network node within a homogeneous portion to forward wired and/or wireless traffic, in a heterogeneous enterprise network. For example, as shown in FIG. 6, a controller-to-controller tunnel (shown as the tunnel represented by 64 in FIG. 6) can be used to forward wired and/or wireless traffic between WLAN controller 610 and core network node 621 in the heterogeneous enterprise network 600. In some embodiments, such a controller-to-controller tunnel can enable the WLAN controller and the controller of the core network node within the homogeneous portion to make mobility possible across the entire heterogeneous enterprise network.

In some embodiments, network devices in an overlay enterprise network portion of a heterogeneous enterprise network can operate like the network devices in a wireless overlay enterprise network (e.g., overlay enterprise network 100). On one hand, a layer-3 tunnel can be used to forward wireless traffic between a WLAN controller and an access point through intervening wired network nodes in the overlay enterprise network portion of the heterogeneous enterprise network. For example, as shown in FIG. 6, a layer-3 tunnel (shown as the tunnel represented by 65 in FIG. 6) is used to forward wireless traffic between WLAN controller 610 and access point 652 through intervening core network node 622, aggregation network node 632 and access network node 644. Thus, wireless user communication device 692 can send wireless traffic to and/or receive wireless traffic from other devices operatively coupled to the heterogeneous enterprise network 600 through the layer-3 tunnel between access point 652 and WLAN controller 610.

On the other hand, a layer-3 tunnel can be used to forward wired traffic between two wired network nodes in the overlay enterprise network portion of the heterogeneous enterprise network. For example, as shown in FIG. 6, a layer-3 tunnel (shown as the tunnel represented by 67 in FIG. 6) can be used to forward wired traffic between core network node 622 and access network node 644 through intervening aggregation network node 632. Thus, a wired user communication device 682 coupled to access network node 644 can send wired traffic to and/or receive wired traffic from, for example, wired user communication device 681 through the layer-3 tunnel between core network node 622 and access network node 644. Alternatively, wired traffic can be transmitted between network devices in the overlay enterprise network portion of the heterogeneous enterprise network without using any tunnel, as described with respect to FIG. 1.

In some embodiments, one or more core network nodes in an enterprise network can be configured to manage a branch deployment of network devices that are operatively coupled to, but located separately from the enterprise network. Such a branch deployment of network devices typically does not include a core network node or any other type of control device that can manage the operations of the network devices. In some embodiments, such a branch deployment of network devices can be operatively coupled to the core network node(s) within the enterprise network through one or more other networks. In the example of FIG. 6, core network node 621 can be configured to manage a branch deployment of network devices (not shown in FIG. 6) that is operatively coupled to core network node 621 through network 601.

Similar to the overlay enterprise network 100, in the overlay enterprise network portion of the heterogeneous enterprise network 600, each wired network node can be individually configured and managed by network administrator 611, while each wireless network node can be configured and managed by WLAN controller 610. That is, access network node 642, access network node 644 and aggregation network node 632 can be manually configured and managed by a network administrator (e.g., network administrator 611) based on their locations in the heterogeneous enterprise network 600 and the nature of the neighboring network devices surrounding them. On the other hand, WLAN controller 610 can be configured to configure and manage access point 652. As described herein, the node management includes for example configuration management (including for example image management), accounting management, performance management, security management, fault management (including for example, monitoring, and/or troubleshooting, etc.

Similar to the homogeneous enterprise network 200, in the homogeneous enterprise network portion of the heterogeneous enterprise network 600, each network node, including each wired network node and each wireless network node, can be configured and managed by one or more core network nodes in a centralized fashion. That is, similar to core network node 221 and core network node 222 in the homogeneous enterprise network 200, core network node 621 can be configured to configure, monitor, and/or troubleshoot access point 651, access point 653, access network node 641, access network node 643, and aggregation network node 631. The details for core network node 621 to configure and manage network nodes in the heterogeneous enterprise network 600 are similar to those of core network node 221 and core network node 222 to configure and manage network nodes in the homogeneous enterprise network 200, which is described above with respect to FIG. 2, therefore not elaborated here.

FIG. 7 is a flow chart of a method for configuring a network node, according to an embodiment. At 702, an initiation signal can be received at a core network node from a network node. Specifically, a network node can be configured to send an initiation signal to a core network node operatively coupled to the network node after the network node is connected to an enterprise network that includes the core network node. The initiation signal can include information associated with the network node that indicates to the core network node the connection of the network node to the enterprise network. In the example of FIG. 2, after access point 251 is operatively coupled to access network node 241, access point 251 is configured to send an initiation signal to core network node 221 through access network node 241 and aggregation network node 231. The initiation signal indicates to core network node 221 that access point 251 is connected to the homogeneous enterprise network 200.

Alternative to the step of 702, at 704, a configuration update signal can be received at the core network node from a network administrator. Specifically, the configuration update signal can include information related to defining configuration information for one or more network nodes operatively coupled to the core network node, such as an instruction to update a template stored in a template table within the core network node, an instruction to redefine configuration information for a network node, etc. In the example of FIG. 2, network administrator 211 can send a configuration update signal to core network node 221, instructing core network node 221 to update a template for access points that is stored in a template table (e.g., template table 512 in FIG. 5) within core network node 221.

At 706, in response to receiving the initiation signal from the network node (as shown in 702) or the configuration update signal from the network administrator (as shown in 704), configuration information can be defined by the core network node for the network node based on a template. Specifically, the core network node can be configured to retrieve a template appropriate for the network node from a template table (e.g., template table 512 in FIG. 5) within the core network node, and then define configuration information for the network node based on the retrieved template. In some embodiments, the configuration information defined for a network node includes information associated with enabling the network node to operate appropriately, and communicate with other network devices in the enterprise network.

For example, as shown in FIG. 2, in response to receiving an initiation signal from access point 251, core network node 221 is configured to retrieve a template for access points from a template table stored in core network node 221, and then define configuration information for access point 251 based on the template for access points. The configuration information defined for access point 251 includes information associated with establishing a MPLS tunnel or a layer-3 tunnel (e.g., the tunnel represented by 20 in FIG. 2) between core network node 221 and access point 251 through access network node 241 and aggregation network node 231.

For another example, as shown in FIG. 2, in response to receiving a configuration update signal from network administrator 211, core network node 221 is configured to update a template for access points accordingly, and then define configuration information for each access point in the homogeneous enterprise network 200, including access point 251 and access point 252, based on the updated template for access points. Similar to the previous example, the configuration information defined for each access point includes information associated with establishing a MPLS tunnel or a layer-3 tunnel between core network node 221 and the access point through intervening wired network nodes.

At 708, the configuration information can be sent from the core network node to the network node through an in-band channel. Specifically, the in-band channel can be a data plane tunnel through one or more intervening wired network nodes, or a data path connecting the core network node with the network node that includes one or more single-hop data paths. In other words, the in-band channel can be established through the same portion of the network as data and not through a separate management networks.

As a result, the network node is configured accordingly based on the received configuration information.

For example, as shown in FIG. 2, core network node 221 can be configured to send the configuration information defined for access point 251 to access point 251 through a data plane tunnel through aggregation network node 231 and access network node 241. Alternatively, core network node 221 can be configured to send the configuration information to access point 251 via a data path that includes three single-hop data paths connecting core network node 221 with aggregation network node 231, connecting aggregation network node 231 with access network node 241, and connecting access network node 241 with access point 251, respectively. Next, access point 251 is configured accordingly based on the received configuration information. As a result, a tunnel (e.g., a MPLS tunnel, a layer-3 tunnel) between core network node 221 and access point 251 can be established when needed, shown as the tunnel represented by 20 in FIG. 2.

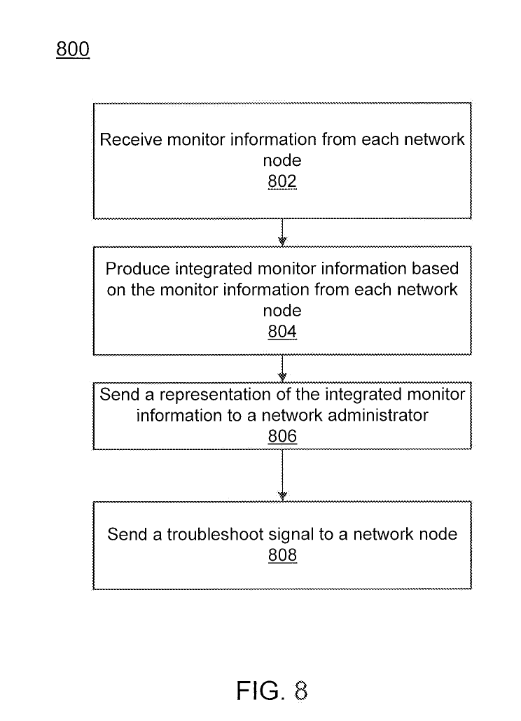

FIG. 8 is a flow chart of a method for monitoring network nodes in an enterprise network and troubleshooting a network node, according to an embodiment. At 802, monitor information can be received at a core network node from each network node. As described with respect to FIG. 2, the monitor information can be any data collected or generated at a network node that is associated with an operational status of the network node and/or any other network node. In some embodiments, the monitor information can be sent from each network node to the core network node through a control channel (e.g., a control plane tunnel, a control path) of the enterprise network that is not used to send any data packet.

For example, as shown in FIG. 2, core network node 221 and/or core network node 222 can be configured to receive monitor information from each network node in the homogeneous enterprise network 200, including access points 251-252, access network nodes 241-244, and aggregation network nodes 231-232. Particularly, the monitor information is sent from each network node to core network node 221 and/or core network node 222 through a control channel (e.g., a control plane tunnel from access network node 242 to core network node 222, a control path connecting aggregation network node 231 with core network node 221, etc.).

At 804, integrated monitor information can be produced by the core network node based on the monitor information from each network node. As described with respect to FIG. 2, the integrated monitor information can be a summary of monitor information received from each network node operatively coupled to the core network node, such as the total number of data packets received at and/or sent from each network node, the total number of data packets dropped at each network node, etc. In the example of FIG. 2, core network node 221 and/or core network node 222 can be configured to produce integrated monitor information based on the monitor information received from each network node in the homogeneous enterprise network 200, where the produced integrated monitor information includes, for example, the total number of data packets dropped at each network node during a certain period of time.

At 806, a representation of the integrated monitor information can be sent from the core network node to a network administrator. As described with respect to FIG. 2, a representation of the integrated monitor information can be any information retrieved from and/or associated with the integrated monitor information, which enables the network administrator to obtain an overview of the operational status of all or a portion of the network nodes in the enterprise network. In the example of FIG. 2, core network node 221 and/or core network node 222 are configured to send a representation of the integrated monitor information to network administrator 211. The representation of the integrated monitor information includes, for example, a list of malfunctioning network nodes in the homogeneous enterprise network 200, each of which has dropped a number of data packets more than a predetermined threshold during the certain period of time.

At 808, a troubleshoot signal can be sent from the core network node to a network node. Specifically, after the integrated monitor information is produced at the core network node and/or the representation of the integrated monitor information is sent to the network administrator, the core network node is configured to determine one or more malfunctioning network nodes that are to be troubleshot. Thus, the core network node is configured to send a troubleshoot signal to each of the malfunctioning network node, respectively. Similar to the monitor information sent from each network node to the core network node, the troubleshoot signal(s) is sent through a control channel (e.g., a control plane tunnel, a control path) of the enterprise network that is not used to send any data packet. In some embodiments, the troubleshoot signal is generated at the core network node by a network administrator or based on an instruction from the network administrator. In some other embodiments, the troubleshoot signal is automatically generated by the core network node without any interaction with the network administrator. After receiving the troubleshoot signal, the network node is configured to go through a troubleshooting procedure accordingly based on the troubleshoot signal.

In the example of FIG. 2, a list of malfunctioning network nodes including access network node 243 is sent from core network node 221 and/or core network node 222 to network administrator 211 as the representation of the integrated monitor information. In response to receiving the list of malfunctioning network nodes, network administrator 211 sends an instruction signal to core network node 221, instructing core network node 221 to troubleshoot each of the malfunctioning network nodes including access network node 243. As a result, core network node 221 is configured to generate a troubleshoot signal for access network node 243 based on the instruction signal from network administrator 211. Core network node 221 is then configured to send the troubleshoot signal to access network node 243 via a control plane tunnel through aggregation network node 231, which is different from the data plane tunnel (shown as the tunnel represented by 22 in FIG. 2) between core network node 221 and access network node 243. After receiving the troubleshoot signal, access network node 243 is configured to go through a troubleshooting procedure accordingly based on the troubleshoot signal.

Although FIG. 7 and FIG. 8 are discussed in connection with the example in FIG. 2 of a homogeneous enterprise network, the method illustrated by FIG. 7 and/or FIG. 8 can be also used on the homogeneous enterprise network portion of a heterogeneous enterprise network (e.g., the heterogeneous enterprise network 600 in FIG. 6).

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

While described above with respect to FIGS. 2-8 as a core network node being able to configure, monitor, and/or troubleshoot network nodes in a centralized fashion, in other embodiments, a core network node can also or alternatively be configured to perform image management for each of the network nodes in the enterprise network in a centralized fashion. Specifically, a core network node can be configured to maintain the image associated with each network node at the core network node. Upon a network node being coupled to the enterprise network, the core network node can be configured to send the image associated with the network node to the network node. In such embodiments, image management is performed in a centralized fashion at the core network node, which is similar to configuration management for each network node in the enterprise network, therefore not elaborated in detail here. In other words, a core network node can perform various forms of network management in a centralized fashion including, for example, configuration management (including for example image management), accounting management, performance management, security management, fault management (including for example monitoring and/or troubleshooting).

While shown and described above with respect to FIG. 5 as template table 512 being included in memory 510 within core network node 500, in other embodiments, a template table can be located in a memory separate from and operatively coupled to a core network node. In some embodiments, a template table can be located in a memory within a separate device that is operatively coupled to a core network node. In such embodiments, the core network node can be configured to access the memory that hosts the template table to retrieve and/or update a template stored in the template table. For example, a control module (e.g., control module 524 in FIG. 5) of the core network node can be configured to send a control signal to the memory that hosts the template table, instructing a template stored in the template table to be modified. For another example, the control module of the core network node can be configured to send another control signal to the memory that hosts the template table, instructing a template stored in the template table to be retrieved and then sent to the core network node, such that the core network node can be configured to define configuration information for a network node based on the retrieved template.

While shown and described above with respect to FIG. 5 as control module 524 being included in core network node 500, in other embodiments, a control module can be separate from and operatively coupled to a core network node. In some embodiments, a control module can be located on a separate device that is operatively coupled to a core network node. In such an example, the control module can be configured to manage wired and/or wireless sessions and apply user policies to wired and/or wireless sessions by sending signals (e.g., control signals) to and receiving signals from the core network node. For example, the control module can send a control signal to a tunnel module in the core network node, instructing the tunnel module to encapsulate or decapsulate a received packet, according to a predetermined tunneling protocol (e.g., a layer-3 tunneling protocol, MPLS). For another example, the control module can send a control signal to a processor of the core network node, instructing the processor to compare information associated with a user session with data stored in a policy table within the core network node, such that an appropriate user policy can be determined and applied on the user session.

While shown and described above with respect to FIG. 1 as aggregation network nodes 131-132 with their associated access network nodes 141-144 and access points 151-152 comprising a pod, in other embodiments, a pod can include less than two or more than two aggregation network nodes and their associated access devices (e.g., access network nodes, access points). As described herein, a pod is defined as a collection of aggregation network nodes and associated access devices having a common connection to a redundant set of core network nodes. Furthermore, while shown and described above with respect to FIGS. 1, 2, 7 and 8 as a redundant set of core network nodes connected to a pod including two core network nodes, in other embodiments, such a redundant set of core network nodes can include more than two core network nodes. For example, a cluster of any number (e.g., 3, 4, 5, etc.) of core network nodes can be coupled to a pod of aggregation network nodes and their associated access devices. Each core network node in the cluster of core network nodes can function as a controller, a hop and/or a switch for the network devices included in the pod associated with the cluster of core network nodes.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and read-only memory (ROM) and RAM devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. An apparatus, comprising:
a core network node configured to be operatively coupled to a plurality of network nodes including a wired network node and a wireless network node, the core network node configured to define configuration information for a network node from the plurality of network nodes based on a template, the core network node configured to send the configuration information to the network node.

2. The apparatus of claim 1, wherein the core network node is configured to receive an initiation signal from the network node, the core network node is configured to define the configuration information for the network node in response to receiving the initiation signal.

3. The apparatus of claim 1, wherein the core network node receives a configuration update signal from a network administrator, the core network node is configured to define the configuration information for the network node in response to receiving the configuration update signal.

4. The apparatus of claim 1, wherein:
the plurality of network nodes includes a plurality of wired network nodes and a plurality of wireless network nodes,
the core network node configured to receive a first tunneled packet associated with a first session from a wired network node from the plurality of wired network nodes through intervening wireless network nodes from the plurality of wireless network nodes,
the core network node configured to receive a second tunneled packet associated with a second session from a wireless network node from the plurality of wireless network nodes through intervening wired network nodes from the plurality of wired network nodes.

5. The apparatus of claim 1, wherein:
the plurality of network nodes includes a plurality of wired network nodes and a plurality of wireless network nodes,
the core network node configured to receive a first tunneled packet associated with a first session from a wired network switch from the plurality of wired network nodes, the core network node configured to send through a control plane tunnel at least one of VLAN information or IP subnet information to a wired user communication device associated with the first tunneled packet,
the core network node configured to receive a second tunneled packet associated with a second session from a wireless network node from the plurality of wireless network nodes through intervening wired network nodes from the plurality of wired network nodes, the core network node configured to send through a control plane tunnel at least one of VLAN information or IP subnet information to a wireless user communication device associated with the second tunneled packet.

6. The apparatus of claim 1, wherein the core network node is configured to send the configuration information to the network node via an in-band channel and not through a separate management network.

7. The apparatus of claim 1, wherein:
the plurality of network nodes including a first network node and a second network node, the core network node is configured to define configuration information for the first network node based on the template, the core network node is configured to define configuration information for the second network node based on the template,
the core network node is configured to send the configuration information for the first network node and the second network node based on a multicast signal.

8. The apparatus of claim 1, wherein:
the core network node configured to receive monitor information from each network node from the plurality of network nodes,
the core network node configured to send a first troubleshoot signal to the network node based on the monitor information such that the network node receives the first troubleshoot signal without receiving a second troubleshoot signal originated from any network node from the plurality of network nodes.

9. An apparatus, comprising:
a core network node configured to be operatively coupled to a plurality of network nodes, the core network node configured to define configuration information for each network node from the plurality of network nodes, the core network node configured to send the configuration information to each network node from the plurality of network nodes through an in-band channel.

10. The apparatus of claim 9, wherein:
the plurality of network nodes including a first network node, a second network node and a third network node,
the core network node is configured to define configuration information for the first network node based on a first template from a plurality of templates,
the core network node is configured to define configuration information for the second network node based on the first template,
the core network node is configured to define configuration information for the third network node based on a second template from the plurality of templates.

11. The apparatus of claim 9, wherein:
the plurality of network nodes including a first network node and a second network node, the core network node is configured to define configuration information for the first network node based on a first template from a plurality of templates, the core network node is configured to define configuration information for the second network node based on the first template,
the core network node is configured to send the configuration information for the first network node and the second network node based on a multicast signal.

12. The apparatus of claim 9, wherein:
the plurality of network nodes includes a plurality of wired network nodes and a plurality of wireless network nodes,
the core network node configured to receive a first tunneled packet associated with a first session from a wired network switch from the plurality of wired network nodes, the core network node configured to send through a tunnel of the control plane at least one of VLAN information or IP subnet information to a wired user communication device associated with the first tunneled packet,
the core network node configured to receive a second tunneled packet associated with a second session from a wireless network node from the plurality of wireless network nodes through intervening wired network nodes from the plurality of wired network nodes, the core network node configured to send through a tunnel of the control plane at least one of VLAN information or IP subnet information to a wireless user communication device associated with the second tunneled packet.

13. The apparatus of claim 9, wherein:
the configuration information excluding VLAN information or IP subnet information,
the core network node configured to receive a tunneled packet from a wired network switch from the plurality of wired network nodes, the core network node configured to send through a connection of the control plane at least one of VLAN information or IP subnet information to a wired user communication device associated with the tunneled packet.

14. The apparatus of claim 9, wherein:
the configuration information excluding VLAN information or IP subnet information,
the core network node configured to receive a tunneled packet from a wireless network node from the plurality of wireless network nodes through intervening wired network nodes from the plurality of wired network nodes, the core network node configured to send through a connection of the control plane at least one of VLAN information or IP subnet information to a wireless user communication device associated with the tunneled packet.

15. The apparatus of claim 9, wherein the core network node is a first core network node, the apparatus further comprising:
a memory configured to be operatively coupled to the first core network node and configured to store a template table associated with the configuration information for each network node from the plurality of network nodes,
a second core network node configured to be operative coupled to the first core network node and the memory.

16. An apparatus, comprising:
a core network node configured to be operative within a network including a plurality of network nodes having a plurality of wired network nodes and a plurality of wireless network nodes, the core network node configured to receive monitor information from each network node from the plurality of network nodes,
the core network node configured to send at least one troubleshoot signal to a network node from the plurality of network nodes based on the monitor information for that network node received from at least one network node from the plurality of network nodes such that the network node receives the at least one troubleshoot signal without receiving another troubleshoot signal originated from a remaining portion of the network.

17. The apparatus of claim 16, wherein the core network node is configured to produce integrated monitor information based on the monitor information from each network node from the plurality of network nodes, the core network node is configured to output a representation of the integrated monitor information.

18. The apparatus of claim 16, wherein the plurality of wired network nodes includes an aggregation network node and an access network node, the plurality of wireless network nodes includes an access point.

19. The apparatus of claim 16, wherein:
the core network node is configured to send configuration information to each network node from the plurality of network nodes through an in-band channel and not through a separate management network, before receiving the monitor information,
the core network node configured to receive the monitor information and send the at least one troubleshoot signal through the control plane.

20. The apparatus of claim 16, wherein:
the core network node is configured to receive a configuration update signal from a network administrator, the core network node is configured to define configuration information for each network node from the plurality of network nodes in response to receiving the configuration update signal, the core network node is configured to send the configuration information to each network node from the plurality of network nodes through an in-band and not through a separate management network, before receiving the monitor information,
the core network node is configured to produce integrated monitor information based on the monitor information from each network node from the plurality of network nodes, the core network node is configured to output a representation of the integrated monitor information to the network administrator.

21. The apparatus of claim 16, wherein:
the core network node is configured to define configuration information for each network node from the plurality of network nodes based on a plurality of templates, the configuration information excluding VLAN information or IP subnet information,
the core network node configured to send the configuration information to each network node from the plurality of network node through an in-band channel and not through a separate management network.
